(19) United States
(12) Patent Application Publication
(10) Pub. No.: US 2011/0044035 A1
(43) Pub. Date: Feb. 24, 2011

(54) PARALLEL BRIDGE CIRCUIT STRUCTURE AND HIGH-VOLTAGE PARALLEL BRIDGE CIRCUIT STRUCTURE

(75) Inventors: Ming-Hung Chen, Zhudong Town (TW); Shih-Yi Wen, Zhudong Town (TW); Hsin-Tai Lin, Zhudong Town (TW); Jing-Yi Chen, Zhudong Town (TW)

Correspondence Address: Juan Carlos A. Marquez;c/o Stites & Harbison PLLC, 1199 North Fairfax Street, Suite 900, Alexandria, VA, 22314-1437, US

(73) Assignee: Helio Optoelectronics Corporation, Zhudong Town (TW)

(21) Appl. No.: 12/937,784

(22) PCT Filed: Apr. 16, 2008
(86) PCT No.: PCT/CN2008/000779

§ 371 Date: Oct. 14, 2010

(51) Int. Cl. F21V 33/00; H02M 7/06

(52) U.S. Cl. 362/227; 363/126

(57) ABSTRACT

A parallel bridge circuit structure and a high-voltage parallel bridge circuit structure are disclosed. The parallel bridge circuit structure includes a first bridge circuit and a second bridge circuit. The first bridge circuit includes a plurality of first diodes, and the second bridge circuit includes a plurality of second diodes. Each of the second diodes is exclusively connected to one of the first diodes in parallel. With the design of the parallel connection between the first bridge circuit and the second bridge circuit, break of the entire circuit caused by a damaged diode is prevented. Moreover, with the aid of the AC signal phase delay circuit structure, the output voltage of the parallel bridge circuit structure can be stable and continuous voltage, while the high-voltage parallel bridge circuit structure includes a plurality of parallel bridge circuit structures so as to endure a high voltage input.

### BACKGROUND OF THE INVENTION

1. Technical Field

The present invention relates to parallel bridge circuit structures, and more especially, to a parallel bridge circuit structure and high-voltage parallel bridge circuit structure capable suitable for AC power supply.

2. Description of Related Art

An LED (Light Emitting Diode) is a type of semiconductor component. Its semiconductor characteristic enables it to give out light by having electrons associated with electron holes (i.e. cavities) to thereby give out photons. Alike other common electronic components, an LED works at room temperature and is advantageously compact and electricity-saving. The service life of LEDs is several times longer than traditional fluorescent lights or halogen lamps, allowing LEDs to become a popular illumination tool of the next generation and to be widely utilized in illumination, backlight modules and other related industries.

However, as LEDs can only work with DC power, it cannot be used under commercial AC power supply conditions; therefore, only when the AC power is converted to DC power through rectifiers, can the LED be effectively utilized without scintillation. As extra rectifiers are needed for the rectification procedure, the entire costs of product manufacturing are increased.

Taiwan Utility Model Patent No. M265741 has disclosed a Bridge LED Drive Gear Using AC power as Direct Drive comprising a plurality of bridge circuits, a first shunt unit and a second shunt unit. It aims at providing a drive gear in a structure as simple as possible in order to lighten plural LED components with AC power.

The foregoing prior-art bridge LED drive gear uses a positive half-cycle current output from an AC power supply to lighten a half of the LEDs, and then uses a negative half-cycle current output from the AC power supply to lighten the other half of the LEDs. However, as the diodes on the bridge circuit are connected in series to the LEDs, the circuit will break if any of the diodes or LEDs fails, further leading to failure of the entire corresponding half of the LEDs.

Moreover, after receiving an input voltage, an LED will remain unlightened until a threshold voltage V-th is achieved, and thus there is a starting time before the LED is lightened. In addition, AC power is periodical power with a positive and negative period and the LED can be lightened alternately by positive and negative half-cycle current outputs from AC power supply, and only when the input voltage is higher than the threshold voltage V-th, can the LED conduct electricity after a starting time, so the LED will scintillate.

Therefore, the abovementioned prior LEDs have defects on structure and inconveniences in applications, thereby requiring improvement. To address the problems above, the related manufacturers have made great efforts to seek a solution, but they have long been unable to develop and work out a suitable design, while common products still have no proper structure to solve the above problems, which is obviously urgent for those working on this. Consequently, creating a new parallel bridge and high-voltage parallel bridge circuit structure becomes one of the important research and development topics, and a necessary achievement in the industry.

Considering the existing defects of the LED driving circuits, the present inventor, based on years of rich practical experience and professional knowledge of the design and manufacturing of these products, through coordination with the theoretical utilization and active research and innovation, expects to create a new parallel bridge circuit structure and a high-voltage parallel bridge circuit structure able to improve the existing LED driving circuits in practicality. After constant research and design, and repeated sample manufacturing and improvement, the present invention with practical value has been created.

### BRIEF SUMMARY OF THE INVENTION

The present invention aims at overcoming the defects in the existing LED driving circuits and providing a novel parallel bridge circuit structure and a novel high-voltage parallel bridge circuit structure, wherein the technical problem required to be solved is to make a parallel bridge circuit structure composed of a first bridge circuit and a second bridge circuit in parallel connection. Due to the dual channel design of the parallel bridge structure, either of the bridge circuits is independent of the failure happening to any diode of the other, so that the entire structure is secured from break. Moreover, the parallel bridge circuit structure can endure relatively heavy current due to its configuration.

An other objective of the present invention is to provide a high-voltage parallel bridge circuit structure, comprising at least two parallel bridge circuits in series connection and thereby enduring high voltage input.

To accomplish the objectives of the present invention and the measures to solve the technical problem, the parallel bridge circuit structure provided by the present invention comprises a first bridge circuit and a second bridge circuit, wherein the first bridge circuit comprises a plurality of first diodes, and the second bridge circuit comprises a plurality of second diodes, in which each said second diode is exclusively connected to one said first diode in parallel.

The objectives of the present invention and the solution to the technical problems are further realized by the technical measures provided below.

In the abovementioned parallel bridge circuit structure or the high-voltage parallel bridge circuit structure, the first diode is a first light emitting diode, and the second diode is a second light emitting diode.

The abovementioned parallel bridge circuit structure further comprises at least an AC signal phase delay circuit, which is in series connection with one of the first diodes or one of the second diodes.

In the abovementioned parallel bridge circuit structure, the AC signal phase delay circuit is a resistance-capacitance phase delay circuit.

To further accomplish the objectives of the present invention and the solution to the technical problems, the high-voltage parallel bridge circuit structure provided by the present invention comprises at least two parallel bridge circuits in series connection, wherein the parallel bridge circuits are a first bridge circuit and a second bridge circuit respectively, the first bridge circuit comprising a plurality of first diodes, and the second bridge circuit comprising a plurality of second diodes, wherein each said second diode is exclusively connected to one said first diode in parallel.

The objectives of the present invention and the solution to the technical problems are further realized by the technical measures provided below.

In the high-voltage parallel bridge circuit structure, the first diode is a first light emitting diode, and the second diode is a second light emitting diode.

The abovementioned high-voltage parallel bridge circuit structure further comprises at least an AC signal phase delay circuit, which is in series connection with one of the first diodes or one of the second diodes.

In the abovementioned high-voltage parallel bridge circuit structure, the AC signal phase delay circuit is a resistance-capacitance phase delay circuit.

Comparing with the prior art, the present invention has obvious advantages and favorable effects. Based on the above, to achieve the abovementioned objectives, the present invention provides a parallel bridge circuit structure comprising a first bridge circuit and a second bridge circuit, wherein the first bridge circuit comprises a plurality of first diodes, and the second bridge circuit comprises a plurality of second diodes, in which each said second diode is exclusively connected to one said first diode in parallel.

To achieve the abovementioned objectives, the present invention also provides a high-voltage parallel bridge circuit structure comprising at least two parallel bridge circuits in series connection, wherein the parallel bridge circuits are a first bridge circuit and a second bridge circuit respectively, the first bridge circuit comprising a plurality of first diodes, and the second bridge circuit comprising a plurality of second diodes, wherein each said second diode is exclusively connected to one said first diode in parallel.

By adopting the abovementioned technical solutions, the parallel bridge circuit structure and the high-voltage parallel bridge circuit structure have at least the following advantages and favorable effects:

1. The parallel bridge circuit structure can prevent open circuit caused by a damaged diode, which will further cause the break of the entire circuit;

2. As two groups of bridge circuits are in parallel connection, the entire circuit can endure a large current input; and

3. Multiple groups of parallel bridge circuits can be connected in series so as to endure a high voltage input.

To sum up, the present invention has many advantages and practical value. It has great improvement on both the product structure and functions, and therefore great technical progress is achieved with more convenient and practical effects. Compared with the existing LEDs, it has outstanding improved functions, thus becoming more practical and featuring an innovative, progressive and practical new design.

The description above is only a brief summary of the technical solution of the present invention. To have a clearer understanding of the technical method of the present invention, people may carry out the invention according to the specification. For making the abovementioned objectives, other objectives, characteristics and advantages more understandable, the present invention is detailed by citing the preferred embodiments in combination with the drawings as follows.

### BRIEF DESCRIPTION OF THE SEVERAL VIEWS OF THE DRAWINGS

FIG. 1A is a diagram of a parallel bridge circuit structure of a first embodiment of the present invention.

FIG. 1B is a voltage waveform diagram of the parallel bridge circuit structure shown in FIG. 1A.

FIG. 2A is a diagram of a parallel bridge circuit structure of a second embodiment of the present invention.

FIG. 2B is a voltage waveform diagram of the parallel bridge circuit structure shown in FIG. 2A.

FIG. 3 is a diagram of a high-voltage parallel bridge circuit structure of the first embodiment of the present invention.

FIG. 4 is a diagram of a high-voltage parallel bridge circuit structure of the second embodiment of the present invention.

### DETAILED DESCRIPTION OF THE INVENTION

In order to further describe the technical method adopted for reaching the intended objectives and the functions of the present invention, the present invention is detailed according to embodiments, structure, characteristics and the functions of the parallel bridge circuit structure and the high-voltage parallel bridge circuit structure disclosed by the present invention in combination with the drawings and the preferred embodiments as follows.

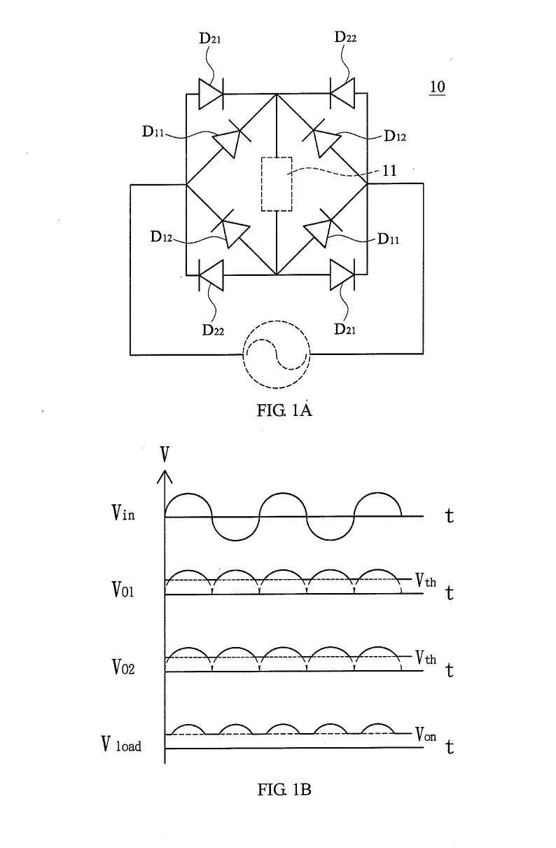

As shown in FIG. 1A, the present embodiment is a parallel bridge circuit structure 10, comprising a first bridge circuit and a second bridge circuit. The first bridge circuit comprises a plurality of first diodes D11, D12, D13, and D14. After the input of AC power, the first diodes D11 and D13 in series connection with a first return circuit will conduct electricity when the positive half-cycle of the AC power flows through, and the first diodes D12 and D14 in series connection with a second return circuit will conduct electricity when the negative half-cycle of the AC power flows through. The first return circuit comprises an AC power supply, a first diode D11, a load 11 and another first diode D13, and the second return circuit comprises an AC power supply, a first diode D12, a load 11 and another first diode D14.

The second bridge circuit comprises a plurality of second diodes D21, D22, D23, and D24, wherein each of the second diodes D21, D22, D23, and D24 is exclusively connected to one of the first diodes D11, D12, D13, and D14 in parallel. Similarly, after the input of AC power, the second diodes D21 and D23 in series connection with the third return circuit will conduct electricity when the positive half-cycle of the AC power flows through, and the second diodes D22 and D24 in series connection with the fourth return circuit will conduct electricity when the negative half-cycle of the AC power flows through. The third return circuit comprises an AC power supply, a second diode D21, a load 11 and another second diode D23, and the fourth return circuit comprises an AC power supply, a second diode D22, a load 11 and another second diode D24.

An output end of the first bridge circuit and that of the second bridge circuit may be connected in series to a load 11, for example an LED. After the input of AC power, the first diode D11, D13 and the load 11 in the first return circuit of the first bridge circuit and the second diode D21 and D23 in the third circuit of the second bridge circuit will conduct electricity when the positive half-cycle of the AC power flows through.

Furthermore, after the input of AC power, the first diode D12, D14 and load 11 in the second return circuit of the first bridge circuit and the second diode D22 and D24 in the fourth circuit of the second bridge circuit will conduct electricity when the negative half-cycle of the AC power flows through. Therefore, the load 11 will conduct electricity when both the positive and negative half-cycle of the AC power flows through.

As shown in FIG. 1B, after an AC power input voltage Vin is rectified by the first bridge circuit and the second bridge circuit, an output voltage VO1 of the first bridge circuit and an output voltage VO2 of the second bridge circuit are both positive half-cycle voltages. However, the diodes will conduct electricity after a starting time as the output voltage VO1 of the first bridge circuit and the output voltage VO2 output of the second bridge circuit must be higher than the threshold voltage Vth of the diodes. Nevertheless, as the first diodes D11, D12, D13, D14 and the second diodes D21, D22, D23, D24 can conduct electricity after a period of start time, a voltage Vload output from the parallel bridge circuit structure 10 to the load 11 is a discontinuous voltage. If the load 11 is an LED, the LED will have a scintillation problem.

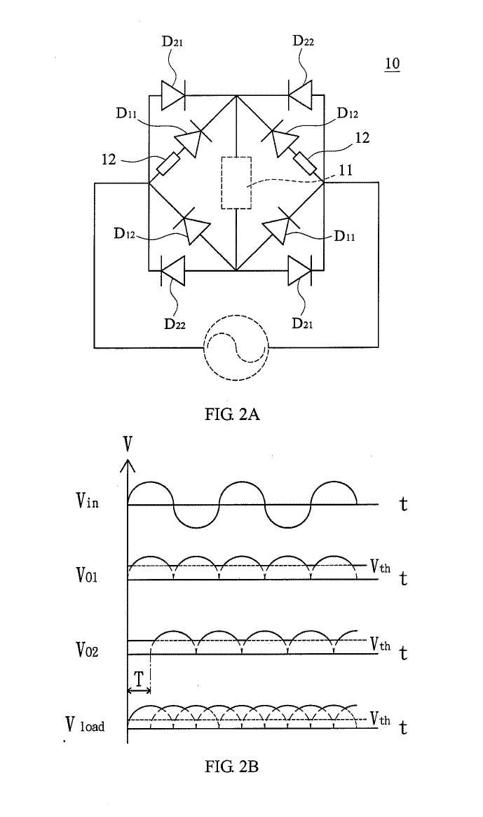

As shown in FIG. 2A, each of the first bridge circuit and the second bridge circuit comprises also at least an AC signal phase delay circuit 12, so as to better fix the scintillation problem of the LED used as load 11. The AC signal phase delay circuit 12 may be connected in series to any of the first diodes D11, D12, D13, D14 or any of the second diodes D21, D22, D23, D24. The AC signal phase delay circuit 12 may be a resistance-capacitance phase delay circuit. Delays at different phases, for example 45 degrees, 90 degrees, etc., may be generated when the resistance value and capacitance value of the resistance-capacitance phase delay circuit is modulated.

As shown in FIG. 2B, the AC signal phase delay circuit 12 may be set to generate phase delay of the output voltage VO1 of the first bridge circuit and the output voltage VO2 of the second bridge circuit, for example 90 degrees. At the same time, a delay time T is also generated. In this way, the output voltage Vload of parallel bridge circuit structure 10 in the present embodiment has extremely small ripples, and is close to be DC power.

Therefore, the AC signal phase delay circuit 12 may be set to make the voltage, which is output to load 11, become a continuous voltage, which is close to be DC power. In this way, if the load 11 is an LED, the scintillation phenomenon of the LED can be reduced, and the LED can give out stable light. Besides, the present embodiment is also applicable to other DC loads, and it can prevent the DC load from being influenced by the periodical changes of the AC power. Also due to the double channel design, parallel bridge circuit structure 10 can endure a large current input and prevent the break of the entire circuit caused by a damaged diode.

The first diodes D11, D12, D13, D14 and the second diodes D21, D22, D23, D24 in the parallel bridge circuit structure 10 may be replaced by LEDs, and therefore become the first LEDs and the second LEDs. After the input of AC power, the first LEDs and the second LEDs in series connection with the first return circuit and the third return circuit can be lightened by the positive half-cycle of the AC power, and the first LEDs and the second LEDs in series connection with the second return circuit and the fourth return circuit can be lightened by the negative half-cycle of the AC power. Therefore, when the first diodes D11, D12, D13, D14 and the second diodes D21, D22, D23, D24 in the parallel bridge circuit structure 10 are replaced by the first LEDs and the second LEDs, the original rectification function will remain, and also the first LEDs and the second LEDs will be lightened during the rectification, so as to improve the brightness of the entire circuit. Moreover, when the AC signal phase delay circuit 12 is connected in series to any of the first diodes D11, D12, D13, D14 or any of the second diodes D21, D22, D23, D24, the scintillation problem of the LEDs used as load 11 can be avoided.

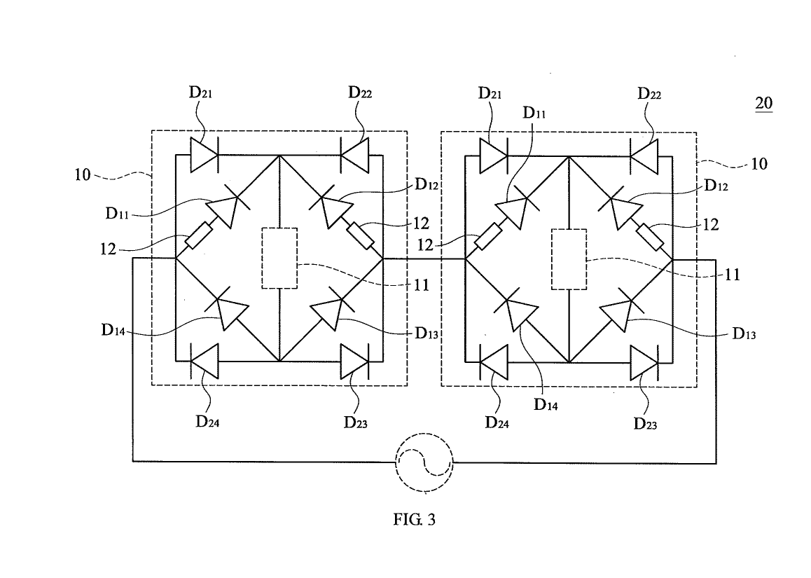

As shown in FIG. 3, a high-voltage parallel bridge circuit structure 20 may comprise at least two parallel bridge circuit structures 10 in series connection, so as to endure a high voltage input. Similarly, the high-voltage parallel bridge circuit structure 20 may use LEDs to replace general diodes for improving the entire brightness, and may also use LEDs as the load 11. In order to avoid the scintillation problem of the LEDs, at least an AC signal phase delay circuit 12 may be connected in series to a first bridge circuit or a second bridge circuit, so that the output voltage of the parallel bridge circuit structure 20 can have extremely small ripples and become close to DC power.

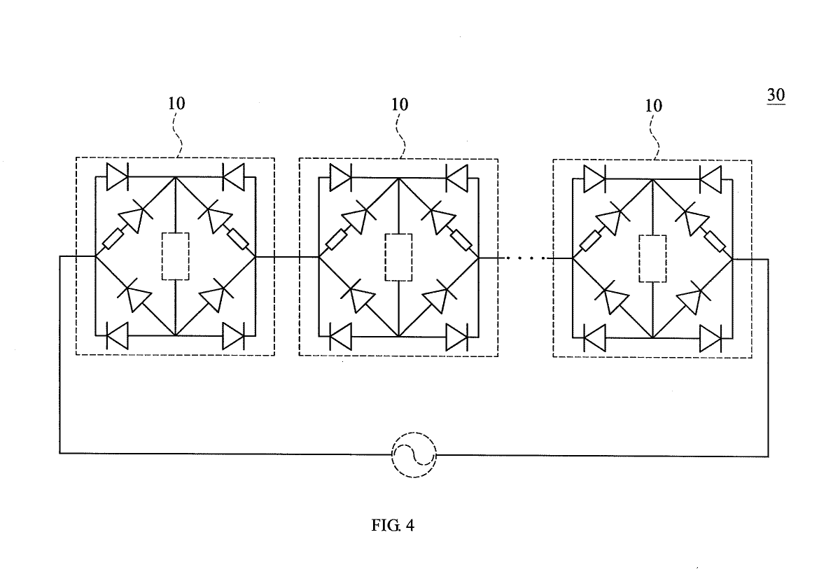

As shown in FIG. 4, a high-voltage parallel bridge circuit structure 30 may comprise N parallel bridge circuit structures 10 in series connection, so as to endure a higher voltage input without an extra voltage limiter circuit. Moreover, due to the dual channel design of the parallel bridge circuit structure 10 for current shunting, the parallel bridge circuit structure 10 can endure a large current input.

The description above is only the preferred embodiments of the present invention other than the restrictions to the present invention. Though the present invention is disclosed by the preferred embodiments above, they are not intended to restrict the present invention. The alterations or modifications made by those skilled in this art without departing from the technical scope disclosed by the present invention above are considered as the equivalent embodiments with slight changes or modifications based on the technical contents disclosed above. Such simple revisions, equivalent changes and modifications are all within the scope of the technical solution of the present invention.

What is claimed is:

1. A parallel bridge circuit structure, comprising:
a first bridge circuit, which comprises a plurality of first diodes; and
a second bridge circuit, which comprises a plurality of second diodes, wherein each of the second diodes is exclusively connected to one said first diode in parallel.

2. The parallel bridge circuit structure as claimed in claim 1, wherein the first diode is a first light emitting diode, and the second diode is a second light emitting diode.

3. The parallel bridge circuit structure as claimed in claim 1, further comprising at least an AC signal phase delay circuit, which is in series connection with one of the first diodes or one of the second diodes.

4. The parallel bridge circuit structure as claimed in claim 3, wherein the AC signal phase delay circuit is a resistance-capacitance phase delay circuit.

5. A high-voltage parallel bridge circuit structure, comprising at least two parallel bridge circuits in series connection, wherein the parallel bridge circuits are a first bridge circuit that comprises a plurality of first diodes, and a second bridge circuit that comprises a plurality of second diodes, in which each said second diode is exclusively connected to one said first diode in parallel.

6. The high-voltage parallel bridge circuit structure as claimed in claim 5, wherein the first diode is a first light emitting diode, and the second diode is a second light emitting diode.

7. The high-voltage parallel bridge circuit structure as claimed in claim 5, further comprising at least an AC signal phase delay circuit, which is in series connection with one of the first diodes or one of the second diodes.

8. The high-voltage parallel bridge circuit structure as claimed in claim 7, wherein the AC signal phase delay circuit is a resistance-capacitance phase delay circuit.
